(19) United States
(12) Patent Application Publication
(10) Pub. No.: US 2011/0074606 A1
(43) Pub. Date: Mar. 31, 2011

(54) Vehicle detection and identification system

(76) Inventors: Stuart O. Goldman, Scottsdale, AZ (US); Paul Wolfson, Evanston, IL (US)

(21) Appl. No.: 12/586,903

(22) Filed: Sep. 29, 2009

(51) Int. Cl. G08G 1/01

(52) U.S. Cl. 340/933; 340/944

(57) ABSTRACT

A vehicle detection and identification system is disclosed that can promote accident avoidance and the reporting of traffic safety violations to public safety personnel, by providing to users (without limitation, visually handicapped users) indicia of vehicles in proximity to the user location, the relative orientation, motion and proximity of the respective vehicles, and identification information associated with the respective vehicles or their owner/operator.

### FIELD OF THE INVENTION

This invention relates generally to traffic safety and, more particularly to devices and methods to promote or enhance the detection and identification of vehicle traffic for purposes of traffic avoidance and/or traffic safety enforcement.

### BACKGROUND OF THE INVENTION

Traffic related fatalities or injuries are a public safety concern of virtually every developed society throughout the world. Thus, there is a continuing need to develop measures to promote and enhance traffic safety. Known measures include, for example, traffic lights, road signs and markings, speed cameras or the like, accompanied by law enforcement measures to enforce traffic safety violations. Traffic safety also relies on human instincts and observations of road users or pedestrians (e.g., eye contact and/or audible recognition of vehicle traffic) to detect and identify vehicle traffic for purposes of traffic avoidance and/or to report observed traffic safety violations. However, the ability of persons to detect and identify vehicle traffic can be compromised by various sensory impairments, interferences or distractions. For example and without limitation, sensory impairments may comprise vision or hearing impairments, or intoxication; interference may result from externalities such as weather conditions, obstructions or the like; and distraction may result from preoccupation with other persons, devices or activities (including “texting,” jogging or cycling). The presence of any of these impairments, interferences or distractions increases the risk of injury or death to the person and decreases the ability of the person to report incidents of traffic safety violations to public safety personnel. A related problem is that hybrid and electric powered vehicles are becoming more prevalent, which run more quietly than traditional vehicle modalities and render audible detection more difficult, most particularly by persons subject to the above noted impairments, interferences or distractions.

### SUMMARY OF THE INVENTION

These problems are addressed and a technical advance is achieved in the art by various devices and methods that promote and enhance the detection and identification of vehicle traffic, including but not limited to hybrid and electric vehicle traffic, thereby promoting accident avoidance and the reporting of traffic safety violations to public safety personnel. Embodiments described herein may be advantageously adapted for specific users or user characteristics (for example, there is an exemplary embodiment for the assistance of visually disabled pedestrians) or applicable to the general public (including vehicle operators, joggers, cyclists or pedestrians) or public safety personnel to assist, enhance or supplement their own instincts and observations in the detection of vehicle traffic.

In one embodiment, there is provided a vehicle detection system comprising one or more vehicular transmitter platforms and one or more detector platforms. The transmitter platforms are deployed on a respective one or more vehicles, for transmitting alerting information associated with the respective vehicles; and the detector platforms are deployed under operation of a respective one or more users at respective user locations. The detector platforms operate to receive the alerting information transmitted in proximity to their user's location, process the alerting information to detect one or more vehicles in proximity to their user's location, and communicate indicia of the vehicles to their user, thereby assisting its user to detect vehicle traffic at the user location.

In another embodiment, there is provided a detector platform, adapted for deployment under operation of a user at a user location, for use in assisting the user to detect vehicle traffic at the user location. The detector platform comprises one or more receivers configured to receive alerting information transmitted from one or more vehicular transmitter platforms in proximity to the user location; an alerting element; and a controller operably coupled to the receivers and the alerting element and configured to (i) process the alerting information to detect one or more vehicles in proximity to the user location; and (ii) activate the alerting element to communicate indicia of the vehicles to the user.

In yet another embodiment, there is provided a method, carried out by a detector platform under operation of a user at a user location, for purpose of assisting the user to detect vehicle traffic at the user location. The method comprises receiving alerting information transmitted in proximity to the user location, from one or more vehicular transmitter platforms in proximity to the user location; processing the alerting information to detect one or more vehicles in proximity to the user location; and communicating indicia of the vehicles to the user.

In still another embodiment, there is provided an apparatus for use in assisting a user to detect vehicle traffic at the user location. The apparatus comprises a plurality of receivers, an alerting element and at least one processor. The plurality of receivers have a corresponding plurality of orientations relative to the user and are configured to receive a plurality of instances of alerting information transmitted from one or more vehicular transmitter platforms in proximity to the user location. The at least one processor is configured to: (i) process the plurality of instances of alerting information to detect at least one vehicle in proximity to the user location and a relative orientation of the vehicle with respect to the user; and (ii) activate the alerting element to communicate indicia of the vehicle and its relative orientation to the user.

In still yet another embodiment, there is provided a method, carried out by an apparatus under operation of a user at a user location, for purpose of assisting the user to detect vehicle traffic at the user location. The method comprises receiving a plurality of instances of alerting information transmitted from one or more vehicular transmitter platforms in proximity to the user location; processing the plurality of instances of alerting information to detect at least one vehicle in proximity to the user location and a relative orientation of the vehicle with respect to the user; and communicating indicia of the vehicle and its relative orientation to the user.

### BRIEF DESCRIPTION OF THE DRAWINGS

The foregoing and other advantages of the invention will become apparent upon reading the following detailed description and upon reference to the drawings in which:

FIG. 1 is a block diagram of a vehicle detection and identification system according to an exemplary embodiment of the invention;

FIG. 2 is a flowchart of steps associated with a vehicle detection and identification system according to an exemplary embodiment of the invention; and

FIG. 3 is a flowchart of steps performed by a detector platform of a vehicle detection and identification system according to an exemplary embodiment of the invention.

### DESCRIPTION OF THE PREFERRED EMBODIMENT(S)

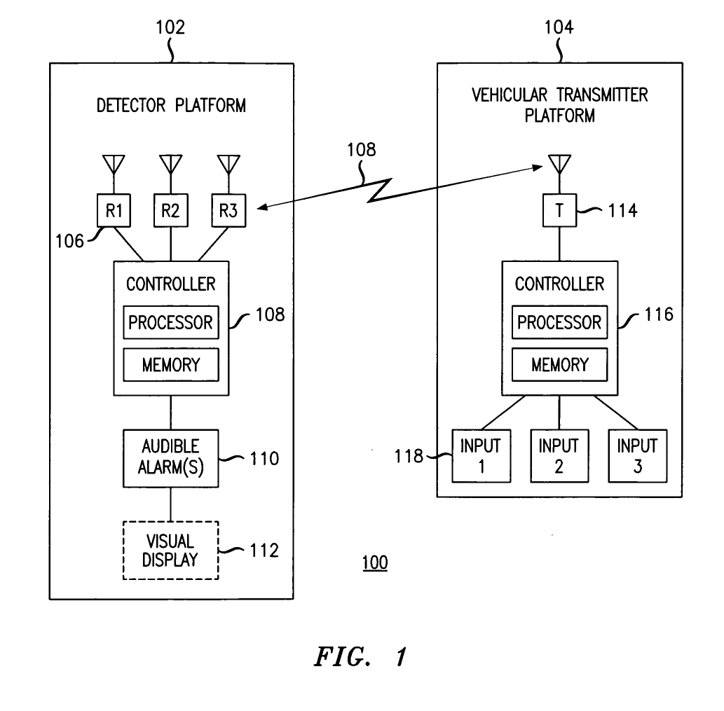

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a vehicle detection and identification system 100 according to embodiments of the invention. The system 100 comprises one or more detector platforms 102 (one shown) and one or more vehicular transmitter platforms 104 (one shown). In one embodiment, the vehicular transmitter platforms 104 are deployed on a respective one or more vehicles (not shown), for transmitting alerting information associated with the respective vehicles; and the detector platforms 102 are deployed under operation of one or more end users, at respective user locations, to receive alerting information transmitted by the vehicular transmitter platforms 104, and to process the alerting information to detect vehicles in proximity to their respective user's location. The detector platforms 102 communicate indicia of the vehicles to their respective users, thereby assisting their users to detect vehicle traffic at the users respective locations.

The vehicular transmitter platforms 104 may also be configured to transmit identification information coincident to transmitting the alerting information; and in such case, in addition to detecting the vehicles, the detector platforms 102 process the information to identify the vehicles in some fashion, and to communicate identification information to their user.

Depending on implementation, the vehicle transmitter platforms 104 may be deployed on virtually any type or nature of vehicle including, without limitation, motor vehicles, hybrid and electric powered vehicles, bicycles or other transportation modalities (e.g., watercraft, aircraft, spacecraft). The detector platforms 102 may be deployed for operation of end users including, without limitation, visually disabled pedestrians, the general public (including vehicle operators, joggers, cyclists or pedestrians) or public safety personnel to assist, enhance or supplement their own instincts and observations in the detection of vehicle traffic.

As will be appreciated, the vehicle transmitter platforms 104 and detector platforms 102 can be implemented in any of several forms or packages depending for example, on the modality of traffic that is being detected or on the particular characteristics, needs or desires of the end users. For example and without limitation, in the case of protecting visually disabled users from road traffic, it is contemplated that the detector platforms may be integrated into a white cane, guide animal harness, eyewear or the like. More generally, the detector platforms may be packaged, for example and without limitation, handheld devices, handheld units, headset devices or clothing or vehicle operated by the end user, and may comprise stand-alone devices or may be integrated with other devices. It is contemplated that vehicular transmitter platforms 104 may comprise an after-market device installed in or on respective vehicles, or may be integrated into the vehicle or components of the vehicle at time of manufacture.

As shown, the detector platform 102 includes one or more receiver elements 106 (as shown, three elements R₁, R₂, R₃), a controller 108, audible alarms 110 and an optional visual display 112. The vehicular transmitter platform 104 includes a transmitter element 114, a controller 116 and one or more input elements 118 (three shown, Input 1, Input 2, Input 3).

The receiver elements 106 of the detector platforms 102 receive alerting information and/or identification information from corresponding transmitter elements 114 of the vehicle transmitter platforms 104 via wireless resources 108. In one embodiment, the receiver elements 106 are arranged in a plurality of orientations relative to the user (for example and without limitation, left-facing, forward-facing, and right-facing) and receive different instances of alerting and/or identification information transmitted from vehicular transmitter platforms in proximity to the user location, each potentially having different signal strengths or characteristics depending on the relative location of the vehicle transmitter platforms. Of course, fewer or greater numbers of receiver elements may be used, and different orientations employed, as a matter of implementation or design choice.

The wireless resources 108 may comprise narrowband frequency modulated channels, wideband modulated signals, broadband modulated signals, time division modulated slots, carrier frequencies, frequency pairs or generally any medium for communicating information from the vehicular transmitter platforms 104 to the detector platforms 102. The wireless resources 108 may implement air interface technologies including but not limited to, CDMA, TDMA, GSM, UMTS or IEEE 802.11.

The controller 108 controls and coordinates operation of the receiver elements 106, and processes the alerting and/or identification information received from the respective receiver elements to detect the presence of vehicles, and advantageously their relative proximity, to the detector platform and hence relative to the user's location. As will be appreciated, the proximity in which vehicles are detectable is a matter of design choice and will depend, at least in part, on the characteristics of the receiver elements 106 and transmitter elements 114 and/or characteristics of the wireless resources 108. Generally, however, it is contemplated that the detector platforms will be capable of detecting vehicles within at least a radius of 50 feet of the detector platform 102.

In one embodiment, the controller 108 processes a plurality of instances of alerting and identification information, individually or collectively from multiple receiver elements to detect not only the presence of vehicles in proximity to the users location, but also the relative orientation of the vehicle with respect to the user. For example and without limitation, in the case where left-facing, forward-facing, and right-facing receiver elements 106 are employed, the controller 108 may process a plurality of instances of alerting and identification information from the left-facing, forward-facing, and right-facing receiver elements, and determine based on relative signal strengths or other signal characteristics that a vehicle is present on the left, or right, or forward relative to the user, as the case may be.

In another embodiment, the controller 108 is operable to detect the relative motion of the vehicle with respect to the user. For example and without limitation, the controller may process consecutive instances of alerting and identification information from particular vehicle transmitter platforms 104 to determine that the corresponding vehicle is approaching or traveling away from the user, and possibly determine the speed of the vehicle.

The controller 108 further coordinates operation of the audible alarms 110 and optional visual display 112 to communicate indicia of the vehicles and their identification information to their user. The audible alarms 110 may include multiple unique frequencies, tones, or sequences to correspond to different information. For example and without limitation, the controller may cause the audible alarms 110 to emit a beeping tone or other suitable alarm sequence when a vehicle is in vicinity of the user. Unique tones or alarm sequences may be used to indicate the relative orientation of the vehicle (e.g., corresponding to left, right, or forward orientation) and the volume, pace, or pitch of the beeping tone may be increased (or decreased) accordingly to indicate the relative proximity and/or relative motion of the vehicle.

The visual display 112 may comprise, for example and without limitation, an LED or LCD display for communicate indicia of the vehicles and their identification via text or images. The visual display is indicated as optional because it may not be useful for visually handicapped users. However, it is contemplated that a visual display would be useful for the general public or public safety personnel, alternatively or additionally to the audible alarms to communicate indicia of the vehicles and their identification information to users.

Referring to the vehicular transmitter platform 104, the transmitter 114 transmits alerting and identification corresponding to the vehicle in which it is deployed, or corresponding to the operator of the vehicle. The controller 116 controls and coordinates operation of the transmitter 114 to deliver the alerting and identification information. The alerting information and/or identification information may comprise, for example and without limitation, license plate number, VIN number or the like associated with the respective vehicles on which the vehicular transmitter platforms are deployed, or drivers license number, contact information, insurance carrier or the like associated with the operators of the respective vehicles.

In one embodiment, the controller 116 obtains the alerting and identification information from respective input elements 118. The input elements are functional elements that may characterize, for example and without limitations, memory locations, or data sources, including or having access to alerting and identification information. The controller 116 receives, processes, formats, supplements and/or filters the information before delivering it to the transmitter 114.

As shown, the controllers 108 and 116 each include a processor and memory. The term “processor” as used herein is intended to include one or more processing devices, including a central processing unit (CPU) or other processing circuitry, including but not limited to one or more signal processors, one or more integrated circuits, and the like. The term “memory” as used herein is intended to include memory associated with a processor or CPU, such as RAM, ROM, a fixed memory device (e.g., hard drive), or a removable memory device (e.g., diskette or CDROM).

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. That is, the CPU may execute software instructions residing in computer-readable signal-bearing media of the detector platform 102 and vehicular transmitter platform 104, respectively, to perform steps associated with transmitting, receiving, processing or communicating detection and identification information.

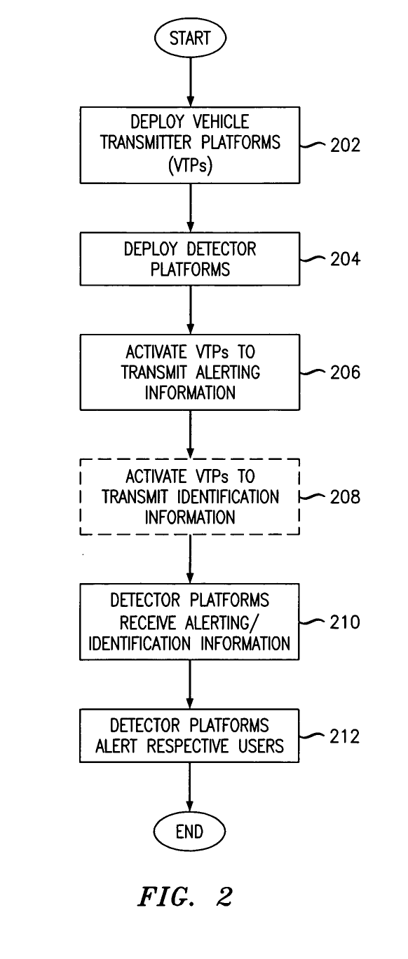

Now turning to FIG. 2, there is shown a flowchart for implementing a vehicle detection and identification system using detector platforms 102 and vehicular transmitter platforms 104 according to an exemplary embodiment of the invention.

At step 202, a responsible authority or agency (or collectively, a plurality of responsible authorities or agencies) deploys vehicular transmitter platforms 104 on or within certain vehicles as needed or desired so as to promote detection and/or identification of the vehicles, and thereby promote accident avoidance and the reporting of traffic safety violations involving the vehicles. As one example, a public safety authority may mandate use of vehicle transmitter platforms on hybrid or electric vehicles, so as to promote detection and identification of the vehicles by visually handicapped users. Generally, it is contemplated that vehicular transmitter platforms may be deployed on virtually any type or combination of types of vehicles including, without limitation, motor vehicles, hybrid and electric powered vehicles, bicycles or other transportation modalities (e.g., watercraft, aircraft, spacecraft).

At step 204, one or more detector platforms 102 are deployed by respective end users, including, without limitation, visually disabled pedestrians, the general public (including vehicle operators, joggers, cyclists or pedestrians) or public safety personnel who desire to receive detection and/or identification information from the transmitter platforms 104.

At step 206, the vehicular transmitter platforms 104 are activated to transmit alerting information corresponding to the vehicles in which in they are deployed. The alerting information may comprise, for example and without limitation, a unique signal, signal pattern or the like to broadcast the presence of the vehicle to detector platforms 102 in range of the signal. Optionally, the alerting information may include telemetry information associated with the vehicle such as, the velocity, heading, geographical coordinates, or the like.

At step 208, the vehicular transmitter platforms may be activated to transmit identification information corresponding to the vehicles or the vehicle operators or owners. The identification information may comprise, for example and without limitation, the license plate number, VIN number or the like associated with the vehicles; and/or drivers license number, contact information, insurance carrier or the like associated with the vehicle operators or owners. The identification information may be communicated coincident to the alerting information or may be communicated separately from the alerting information.

At step 210, the detector platforms receive the alerting and/or identification information transmitted from vehicular transmitter platforms. More particularly, the detector platforms receive different instances of alerting and/or identification information transmitted individually or collectively from one or more vehicular transmitter platforms in proximity to the user location. In one embodiment, the detector platforms process the alerting and/or identification information to detect the presence of vehicles in proximity to the users location and also the relative orientation of the vehicle with respect to the user.

At step 210, the detector platforms alert the respective users of the presence of vehicles in proximity to their location and the relative orientation by means of audible alarms 110 and optionally, my means of a visual display 112.

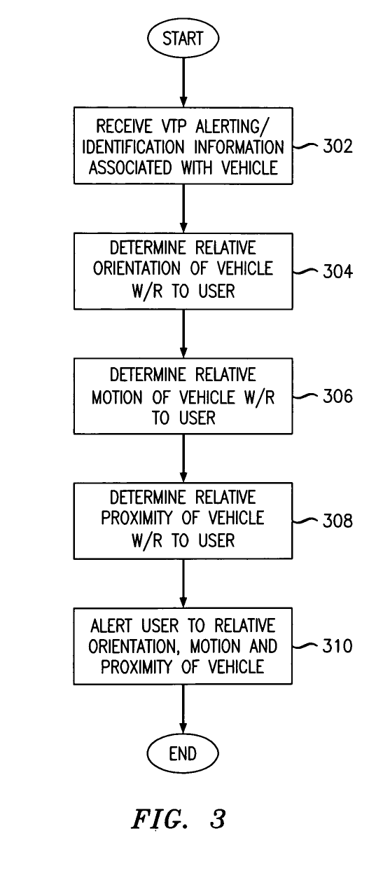

FIG. 3 is a flowchart of steps performed by a detector platform to receive and process alerting information according to an exemplary embodiment of the invention.

At step 302, the detector platforms receive different instances of alerting information transmitted individually or collectively from one or more vehicular transmitter platforms in proximity to the user location.

At step 304, the detector platforms process the alerting information to determine the relative orientation of vehicles in proximity to the users location. In one embodiment, the detector platforms include left-facing, forward-facing, and right-facing receiver elements 106 and process a plurality of instances of alerting information from the left-facing, forward-facing, and right-facing receiver elements to determine based on relative signal strengths or other signal characteristics that a vehicle is present on the left, or right, or forward relative to the user. Alternatively or additionally, the detector platforms may determine the relative orientation of the detected vehicles based on the telemetry contained within the alerting information, such as the heading or geographical coordinates.

At step 306, the detector platforms process the alerting information to determine the relative motion of the detected vehicles in relation to the user. In one embodiment, the detector platforms process consecutive instances of alerting information from particular vehicles to determine whether the vehicles are approaching or traveling away from the user, and possibly determine the speed of the vehicles. Alternatively or additionally, the detector platforms may determine the relative motion of the detected vehicles based on the telemetry contained within the alerting information, such as the velocity, heading or geographical coordinates.

At step 308, the detector platforms process the alerting information to determine the relative proximity of the detected vehicles in relation to the user. In one embodiment, the detector platforms process consecutive instances of alerting information from particular vehicles and determine the relative proximity based on the received signal strength of the alerting information. Alternatively or additionally, the detector platforms may determine the relative proximity of the detected vehicles based on the telemetry contained within the alerting information, such as the velocity, heading or geographical coordinates.

As will be appreciated, steps 304, 306, 308 need not be performed in the order shown. They may be performed in any order, or may be performed simultaneously.

At step 310, the detector platforms communicate indicia of the relative orientation, motion and proximity of the vehicle to the user of the detector platform. For example and without limitation, indicia of vehicle orientation may be communicated by unique beeping tones or alarm sequences corresponding to left, right, or forward orientation; and relative proximity and motion may be communicated by varying the volume, pace, or pitch of the tone. Optionally, the relative orientation, motion and proximity of the vehicle may be communicated by means of the visual display 112.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. Although the invention is described in relation to vehicle detection, the invention may be deployed to enhance detection and identification of virtually any machine, object, person, or animal that is equipped with a transmitter platform. Similarly, although in one aspect the invention is provided for use by visually handicapped persons, or persons subject to impairments, interferences or distractions, it may be utilized or adapted for use by persons without regard to their physical characteristics or impairments.

The scope of the invention is, therefore, indicated by the appended claims rather than by the foregoing description. All changes that come within the meaning and range of equivalency of the claims are to be embraced within their scope.

What is claimed is:

1. A vehicle detection system comprising:
one or more vehicular transmitter platforms, deployed on a respective one or more vehicles, for transmitting alerting information associated with the respective vehicles; and
one or more detector platforms, deployed under operation of a respective one or more users at respective user locations, each operable to receive the alerting information transmitted in proximity to their user's location, process the alerting information to detect one or more vehicles in proximity to their user's location, and communicate indicia of the vehicles to their user, thereby assisting its user to detect vehicle traffic at the user location.

2. The vehicle detection system of claim 1,
wherein the one or more vehicular transmitter platforms are configured to transmit identification information coincident to transmitting the alerting information; and
the one or more detector platforms are configured to receive the identification information coincident to receiving the alerting information, process the alerting and identification information to detect and identify one or more vehicles in proximity to their user's location, and communicate indicia of the vehicles and their identification information to their user.

3. A detector platform, adapted for deployment under operation of a user at a user location, for use in assisting the user to detect vehicle traffic at the user location, the detector platform comprising:
one or more receivers configured to receive alerting information transmitted from one or more vehicular transmitter platforms in proximity to the user location;
an alerting element; and
a controller operably coupled to the receivers and the alerting element and configured to (i) process the alerting information to detect one or more vehicles in proximity to the user location; and (ii) activate the alerting element to communicate indicia of the vehicles to the user.

4. The detector platform of claim 3, wherein the one or more receivers are configured to receive identification information coincident to receiving the alerting information; and
the controller is configured to (i) process the alerting and identification information to detect and identify one or more vehicles in proximity to the user location; and (ii) activate the alerting element to communicate indicia of the vehicles and their identification information to the user.

5. A method, carried out by a detector platform under operation of a user at a user location, for purpose of assisting the user to detect vehicle traffic at the user location, the method comprising:
receiving alerting information transmitted in proximity to the user location, from one or more vehicular transmitter platforms in proximity to the user location;
processing the alerting information to detect one or more vehicles in proximity to the user location; and
communicating indicia of the vehicles to the user.

6. The method of claim 5, further comprising:
receiving identification information coincident to receiving the alerting information;
processing the identification information to detect and identify one or more vehicles in proximity to the user location; and
communicating indicia of the vehicles and their identification information to the user.

7. The method of claim 6, wherein the step of receiving identification information comprises receiving one or more of: vehicle identification information and vehicle operator information associated with at least a portion of the vehicles.

8. Apparatus for use in assisting a user to detect vehicle traffic at the user location, the apparatus comprising:
a plurality of receivers having a corresponding plurality of orientations relative to the user and configured to receive a plurality of instances of alerting information transmitted from one or more vehicular transmitter platforms in proximity to the user location;
an alerting element; and
at least one processor configured to: (i) process the plurality of instances of alerting information to detect at least one vehicle in proximity to the user location and a relative orientation of the vehicle with respect to the user; and (ii) activate the alerting element to communicate indicia of the vehicle and its relative orientation to the user.

9. The apparatus of claim 8, wherein the at least one processor is further configured to (iii) process the plurality of instances of alerting information to determine relative motion of the vehicle with respect to the user; and (iv) activate the alerting element to communicate indicia of the relative motion of the vehicle to the user.

10. The apparatus of claim 8, wherein the at least one processor is further configured to (v) process the plurality of instances of alerting information to determine a relative proximity of the vehicle to the user; and (vi) activate the alerting element to communicate indicia of the relative proximity of the vehicle to the user.

11. The apparatus of claim 8, wherein the plurality of receivers are configured to receive identification information coincident to receiving the alerting information; and
the at least one processor is further configured to process the identification information to identify the at least one vehicle in proximity to the user location; and activate the alerting element to communicate indicia of the identification information to the user.

12. A method, carried out by an apparatus under operation of a user at a user location, for purpose of assisting the user to detect vehicle traffic at the user location, the method comprising:
receiving a plurality of instances of alerting information transmitted from one or more vehicular transmitter platforms in proximity to the user location;
processing the plurality of instances of alerting information to detect at least one vehicle in proximity to the user location and a relative orientation of the vehicle with respect to the user; and
communicating indicia of the vehicle and its relative orientation to the user.

13. The method of claim 12, further comprising:
processing the plurality of instances of alerting information to determine relative motion of the vehicle with respect to the user; and
communicating indicia of the relative motion of the vehicle to the user.

14. The method of claim 12, further comprising:
processing the plurality of instances of alerting information to determine a relative proximity of the vehicle to the user; and
communicating indicia of the relative proximity of the vehicle to the user.

15. The method of claim 12, further comprising:
receiving identification information coincident to receiving the alerting information;
processing the identification information to identify the at least one vehicle in proximity to the user location; and
communicating indicia of the identification information to the user.

16. The method of claim 15, wherein the step of receiving identification information comprises receiving one or more of: vehicle identification information and vehicle operator information associated with at least one vehicle.
